(19) United States
(12) Patent Application Publication
(10) Pub. No.: US 2009/0028678 A1
(43) Pub. Date: Jan. 29, 2009

(54) Device for Discharging a Stack of Flat Objects Standing on Their Narrow Faces

(75) Inventor: Oliver Kutzer, Radolfzell (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/180,871

(22) Filed: Jul. 28, 2008

(30) Foreign Application Priority Data
Jul. 26, 2007 (DE) DE 102007034947.7

(51) Int. Cl. B07C 1/02; B65G 15/00

(52) U.S. Cl. 414/351

(57) ABSTRACT

A device for discharging a stack of flat objects standing on their narrow faces, in particular a stack of mail items, includes a stack holder with a base for holding the objects and a supporting element supporting the stack. The supporting element is a platform-type wall, preferably with recesses, into which a further supporting element with inverted recesses can pass. The stack holder can be pivoted about an axis of rotation and its base has a conveyor. This ensures that stack quality is preserved during the complete discharging process. The ergonomics of the device are also improved for its operator.

### CROSS-REFERENCE TO RELATED APPLICATION

This application claims the priority, under 35 U.S.C. § 119, of German Patent Application DE 10 2007 034 947.7, filed Jul. 26, 2007; the prior application is herewith incorporated by reference in its entirety.

### BACKGROUND OF THE INVENTION

### Field of the Invention

The invention relates to a device for discharging a stack of flat objects standing on their narrow faces onto a bed using a stack holder with a base to hold the stack and a platform-type supporting element to support the stack.

When a stack of flat objects, such as mail items (e.g. mail items of different sizes and/or strengths) is discharged, the mail items are disposed in a stack in a tilt tray or chute tray unloading device. For example, when the stack is fed onto a loading table of a mail item separator, an operator (mail service operator) displaces the stack by way of a lower surface of the tilt tray onto a feed table of the separator.

Such a tilt tray can therefore be considered to be a conventional device for unloading an object, in particular a stack of flat objects such as mail items of different size. The tilt tray thereby has at least one base for holding the stack and one supporting element for supporting the objects in the stack, with the supporting element extending in a plane, on which a stack face is to be supported.

However that has the following disadvantages:

Ergonomically speaking, the movement described above is associated with a high expenditure of force and it must be executed across the body position of the operator.

When the stack, for example of flat mail items standing on their edges, is displaced, the stack on the tilt tray must be supported on both of its sides by the operator with one hand on each side. In the case of a small stack, that is little space for the lower arms to be used for that purpose.

During operation, the current construction of the tilt tray also means that the operator, before discharging the tilt tray, reaches with one hand between the side wall of the tilt tray and the stack of mail items, where an end face of the stack was supported. Only then is it possible to displace the stack from the tray by hand. Despite the trough-like construction of the side wall, delicate mail items insert themselves into that trough in such a manner that it becomes difficult to reach behind the stack of mail items.

Those ergonomic defects can lead to physical problems in the long term.

With a view to stack quality and due to the high level of force to be expended by the operator, the stack of mail items is regularly not displaced so that it is flush with a so-called parting blade or with an end of the stack of mail items on the loading table. Gaps result in the stack, causing the collapse of the stack in the case of delicate mail items.

The stack of mail items is subject to a force by way of its underside due to its displacement by way of the base-type surface of the tilt tray on the underside. That results in delicate mail items coming apart laterally at their lower edge.

Displacing the stack by way of the underside of the mail items causes the stack to tilt to the side. As the mail items lean on one another, a high stack pressure is exerted.

When a parting blade is deployed on an end face of the stack, the blade must be positioned between the last, as yet unsupported, mail item in the stack and the hand of the operator. If the last mail item is an open magazine, it can become hooked onto a lower edge of the parting blade.

A further hazard is the force acting from top to bottom on the last mail item in the stack, which can be induced by a possible lowering, for example, of a pivotable parting blade in the direction of the underside of the stack. There is a risk that delicate or soft mail items may slide under the parting blade. The lower region of the cover sheet of a magazine can, for example, be folded.

Further separation of such a stack is therefore problematic and can result in interruptions to the run of mail in an automatic separator.

Devices have also been known for feeding loading tables of mail separators of sorting machines, with which stacks of upright flat mail items are supplied through the use of mail containers or stack holders. A boundary or supporting wall is constructed with recesses in that case. In the transfer process, supporting elements with inverted recesses are passed through the recesses of the supporting wall directly up to the stack (see U.S. Pat. No. 6,135,697 and U.S. Patent Application Publication No. US 2005/0077217 A1).

### SUMMARY OF THE INVENTION

It is accordingly an object of the invention to provide a device for discharging a stack of flat objects standing on their narrow faces, in particular a stack of flat mail items, which overcomes the hereinafore-mentioned disadvantages of the heretofore-known devices of this general type and with which a high stack quality is achieved during discharge of the stack of flat objects.

The device should also offer better ergonomics for an operator and be as simple as possible to configure.

With the foregoing and other objects in view there is provided, in accordance with the invention, a device for discharging a stack of flat objects standing on their narrow faces onto a bed. The device comprises a stack holder pivotable about an axis of rotation. The stack holder has a base for holding the stack and a platform-shaped supporting element defining a plane and supporting the stack. The base has a conveyor coupled to the supporting element and configured to simultaneously move the stack and the supporting element perpendicular to the plane of the supporting element. A controllable drive moves the conveyor and pivots the stack holder.

Therefore, a device is proposed for discharging a stack of flat objects standing on their narrow faces onto a bed using a stack holder with a base to hold the stack and a platform-type supporting element to support the stack. It is possible for a further supporting element of the bed with inverted recesses to be moved through the supporting element. The base of the stack holder has a conveyor which is configured to move the stack and the supporting element simultaneously perpendicular to the plane of the supporting element and which is coupled to the supporting element. The stack holder can be pivoted about an axis of rotation and the device includes a controllable drive to move the conveyor and to pivot the stack holder.

It is thus possible to maintain perfect stacking at all times, without the device having to be overly complicated. This aspect also allows optimized ergonomics for an operator of the device, since the simultaneous, synchronous movement creates an effective force to press the stack. The operator only needs one hand for a complete unloading operation.

One face (that is, the end face of the stack) is thereby oriented or supported against the laterally disposed supporting element in the stack holder at one end of the stack. The other end face of the stack can remain in free space in any manner when the mail holder is tilted about the axis of rotation, so that the stack remains flush due to gravity.

According to the invention, the base has the conveyor, which can be motor-controlled, for lateral (i.e. perpendicular to the plane of the supporting element) and synchronous movement of the stack and the supporting element, with the conveyor being coupled to the supporting element and being in contact with a predominant part of the underside of the stack. This ensures movement of the stack by the conveyor without lateral forces acting on the stack and lateral support and bundling of the stack by the synchronous drive of the supporting element in a simple manner. The base thereby only forms a basic holder for the conveyor, which also supports or displaces the stack.

A method for simplified unloading of a stack is also described in more detail below based on the present device.

Other features which are considered as characteristic for the invention are set forth in the appended claims.

Although the invention is illustrated and described herein as embodied in a device for discharging a stack of flat objects standing on their narrow faces, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a stack holder of a discharging device according to the invention;

FIG. 2 is a longitudinal-sectional view of the stack of mail items being supplied by an unloading device;

FIG. 3 is a longitudinal-sectional view of the stack of mail items being swung down by the unloading device;

FIG. 4 is a longitudinal-sectional view of the stack of mail items being driven by the unloading device in the direction of another stack;

FIG. 5 is a longitudinal-sectional view showing the deployment of a parting blade from one side of the stack of mail items to the other;

FIG. 6 is a longitudinal-sectional view showing a backward movement of the unloading device with discharge of the stack of mail items;

FIG. 7 is a longitudinal-sectional view showing an end phase of the backward movement of the unloading device with an upward swing; and

FIG. 8 is an enlarged, perspective view of main components of the unloading device according to FIG. 1 and FIG. 6.

### DETAILED DESCRIPTION OF THE INVENTION

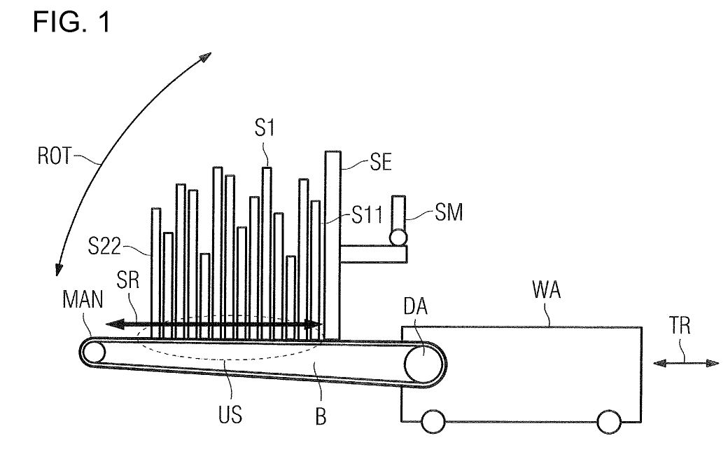

Referring now to the figures of the drawings in detail and first, particularly, to FIG. 1 thereof, there is seen a movable stack holder of a discharging device for a stack S1 of flat objects or mail items standing on their edges and having predominant lower edges which form an underside US of the stack and are oriented on a base B. At one end of the stack S1 one face or side S11 (which is the last mail item in the stack) of the stack is oriented or supported against a supporting element SE. The supporting element SE can be a lateral mesh, for example. The other face or side S22 of the stack S1 can remain in free space as the base B of the unloading device is easily swung upward, so that the stack remains flush against the supporting element SE. The base B has a motor-driven controllable conveyor MAN for lateral and synchronous movement of the stack S1 and the supporting element SE. The movement is carried out in such a way that the conveyor MAN is connected mechanically to the supporting element SE and is in contact with a predominant part of the underside US of the stack S1. In practice, the conveyor MAN can be a rolling belt disposed in an encompassing manner on the base B, which can be moved synchronously with the supporting element SE in a displacement direction SR. In drive mode, at least the stack stands directly on the conveyor MAN and should therefore remain free of contact with the base B. The base B and the supporting element SE are also disposed in such a manner that they form, for example, an L-shaped, scoop-type or fork-type holder or carrier for the stack S1 (in other words they form an angle in the region of 90°). In particular, during the discharging of a stack S1 outside the device, the supporting element SE extends in a vertical direction or is slightly tilted in relation to the vertical direction, so that the stack does not tip in the direction of its free end. To this end the conveyor MAN also has an appropriate frictional force in the region of the underside of the stack S1. In some instances a further, detachable non-illustrated supporting element can be deployed to support the stack at its free end. The base B and the supporting element SE in this case have a common axis of rotation DA, with which the stack holder or receiver can easily be pivoted (see a rotation direction ROT in FIG. 1). It is also advantageous that the axis of rotation DA connects the stack holder to a wagon WA, allowing the stack of mail items to be transported in a transport direction TR. As a result, the operator no longer has to support a tilt tray and can activate the tilting up and down rotation direction ROT of the stack of mail items S1 relative to a (horizontal) deposit surface (as with a feed from a separator). The upward tilt is suitable for the bundled transport of the stack, whereas discharge of the stack is initiated during the downward tilt.

The conveyor MAN is advantageously coupled to a manually and ergonomically actuated or operated control module SM, which is disposed on the supporting element SE, preferably on its free face, and which controls motor movement of the supporting element SE in conjunction with the rolling belt. As a result, the operator in some instances must support the stack of mail items on its free face S22 with one hand, when the downward tilt is initiated. The other hand easily controls the handle-shaped control module SM. This allows the operator also to assume a body position, which cannot cause problems, since there is no need for a non-ergonomic movement across the body position. In some instances, the control module SM can have a manual operating mode, in which a further manual force is exerted on the control module SM to assist the motor movement. This is particularly practical when the operator wishes to initiate more rapid discharging of the stack S1. It is also possible to control the speed of the wagon WA through the use of the control module SM as well as controlling the movement of the supporting element SE. If necessary, operators can also use the control element to exert a force on the control module SM or on the supporting element SE and to assist the motor movement. Since the supporting element SE supports the stack of mail items S1 during an entire discharging process, the operator no longer has to reach with one hand between the side wall and the stack of mail items S1 before discharging the stack holder.

The following advantages should also be mentioned with regard to stack quality during a discharging process:

The motor-driven conveyor with the coupled supporting element ensures constant discharge quality over time. The mail items are always transported flush with a further supporting element or parting blade (e.g. in the case of a loading surface of a mail item separator) or with a further stack of mail items during operation without a parting blade. No gaps occur, which can cause the stack S1 to collapse in the case of delicate mail items.

Due to the belt or belts used as a conveyor on the underside of the stack of mail items S1 and the supporting element SE, the mail items do not move relative to the surfaces that are reached (e.g. to an orientation or loading surface of a mail item separator). Delicate mail items therefore remain in position and do not come apart on their underside.

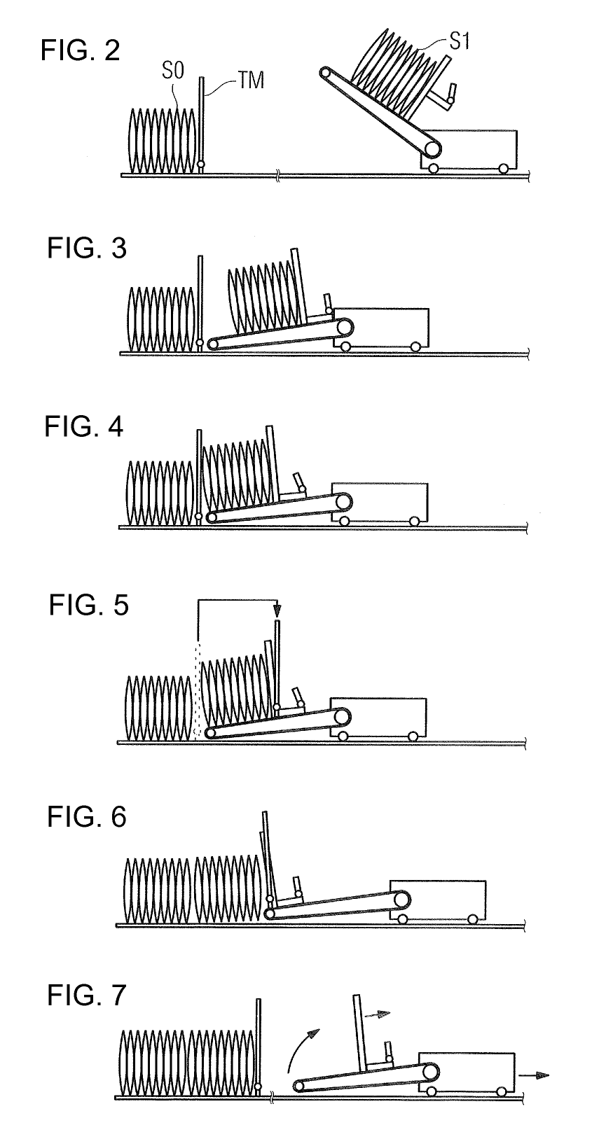

Since the mail items are no longer displaced by way of the base B (the belt or belts on the base “accompany” the mail items, without relative movement or in a fixed manner), the stack S1 does not tilt to the side. The mail items in the stack S1 are moved in an upright position up to a further supporting element or parting blade TM (see FIG. 2) and deposited there. The occurrence of high stack pressure due to mail items leaning on one another is also prevented.

The configuration according to the invention therefore ensures good stack quality for delicate mail items and problem goods. This is a requirement, in particular for a stable separation process with a high throughput over a broad range of mail item formats.

One exemplary embodiment of a method for simplified discharging of the stack S1 during the course of a discharging process on a holding surface and its advantages, is shown in more detail in FIGS. 2 to 7. For reasons of clarity, most of the reference characters indicated in FIG. 1 have been omitted.

FIG. 2 shows the (horizontal) holding surface of the mail item separator with an already unloaded stack S0 of mail items standing on their narrow faces and one end face thereof being supported or oriented on a surface of a supporting element or parting blade TM. A further stack S1 of mail items to be deposited is also to be supplied through the use of a discharging device according to FIG. 1, so that one end face of the stack S1 is unloaded against a free surface of the parting blade TM.

A rolling unloading device according to FIG. 1 is to transport the stack S1 up to the further supporting element or parting blade TM. Before unloading at the parting blade, the base B and the supporting element SE of the stack holder are disposed in such a manner that they form an L-shaped holder for the stack S1.

In FIG. 3 the stack holder is pivoted downward about the axis of rotation DA. The axis of rotation DA connects the stack holder to the wagon WA, which positions the base B in direct proximity to the parting blade TM but the stack S1 to be unloaded can also be some distance from the parting blade TM.

In FIG. 4 the stack S1 is unloaded, in that the motor-controlled conveyor MAN (rolling belt) of the base B and the coupled supporting element SE transport the stack S1 in the direction of the further supporting element or parting blade TM (in some instances with further manual assistance as well). At the end of this process, one end face of the stack S1 is in direct proximity to the parting blade TM, both sides of which are now disposed between the stacks S0, S1.

A further step can now be implemented, in that the parting blade TM can be removed from the holding surface of the mail item separator and can then be pushed into the supporting element SE from one side to the other side by way of recesses. FIG. 5 shows an arrow indicating this procedure and outlining the removal of the parting blade TM and its replacement behind the supporting element SE. During this phase, the stacks S0, S1 are adjacent one another but the stack S1 is still on the base B.

By providing recesses in the parting blade TM and on the supporting element SE, it is possible to position the parting blade TM behind as well as in front of the supporting element SE or to displace it in and out during deployment. This also ensures that when it is lowered behind the supporting element SE, the parting blade TM cannot become hooked onto possible mail items.

The supporting element SE and the parting blade TM can penetrate each other during deployment. For example, the supporting element SE can be a platform-type or platform-shaped wall with recesses, into which the mail item partition wall TM with spatially inverted (or displaced) recesses passes. This can be carried out very simply and easily by an operator even with one hand.

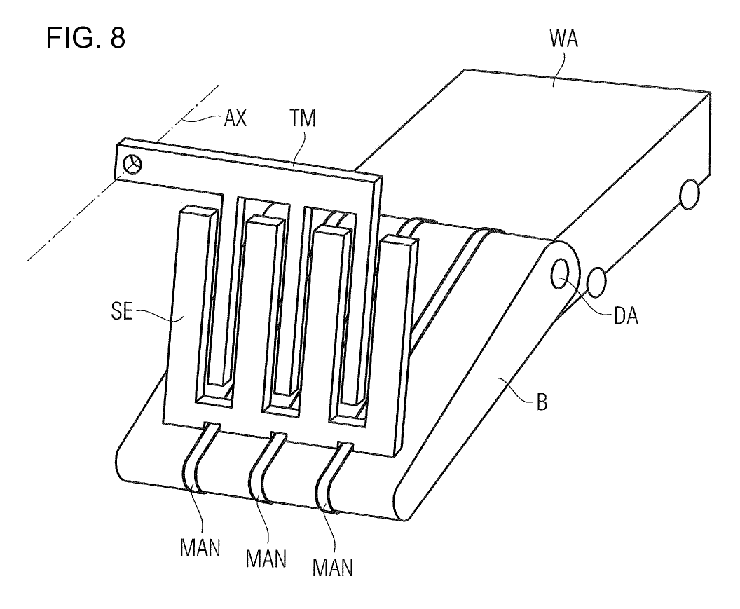

This means that when it is lowered (e.g. behind the supporting element SE) the parting blade TM has no contact with the mail items. It is only when the parting blade TM is fully lowered, that it is displaced (by way of the recesses in the supporting element SE) against the stack S1 to take over the supporting action of the supporting element SE. The last mail item S11 in the stack S1 is not subject to any vertical force, which could cause deformation of the mail item or the stack as a whole. This process is shown in FIG. 6, in which the wagon WA also moves backward. The base B is driven in such a manner in this case that its stack holding surface remains in the same position, with the parting blade TM and in some instances the supporting element SE exerting a horizontal force on the end face S11 of the stack S1. The stack S1 is therefore not moved laterally (i.e. horizontally) and remains in the form of a stack.

FIG. 7 shows the completed discharging process, in which the base B and the wagon WA are some distance from the unloaded stack S1. The parting blade TM remains behind the stack S1 to support it. The L-shaped stack holder can now be pivoted upward, so that a new stack to be discharged can be placed in it.

Finally, FIG. 8 is a perspective view of the main components of the discharging device according to FIG. 1 to FIG. 6, showing that the parting blade TM can penetrate into the supporting element SE by way of appropriate recesses. An operator can thereby position the parting blade TM (shown herein as a partition wall) easily behind the supporting element SE, push it through the supporting element SE and use it as a new supporting element on a new unloading surface outside the unloading device. This also allows an operator of one of the two elements SE, TM to simply press with one hand during the entire unloading process, with the supporting element SE moving simultaneously and synchronously with the conveyor MAN. For reasons of clarity, the stack S1 in the foreground of the figure is not shown. The conveyor MAN in this case is formed of three rolling belts, which can be rotated synchronously and in a fixed manner with respect to the supporting element SE about the base B, so that the stack S1 is unloaded as described or so that the supporting element is moved back in the direction of the wagon WA after discharge. The parting blade TM is secured to a pivot facility with a horizontal axis of rotation AX and is embodied as a rake, which can pass through recesses in the supporting element SE. A non-illustrated anchor can also be deployed for the temporary coupling of the parting blade TM to the supporting element SE. This anchor can be deactivated.

1. A device for discharging a stack of flat objects standing on their narrow faces onto a bed, the device comprising:
a stack holder pivotable about an axis of rotation, said stack holder having a base for holding the stack and a platform-shaped supporting element defining a plane and supporting the stack;
said base having a conveyor coupled to said supporting element and configured to simultaneously move the stack and said supporting element perpendicular to said plane of said supporting element; and
a controllable drive for moving said conveyor and pivoting said stack holder.

2. The device according to claim 1, wherein said conveyor is a rolling belt movable synchronously with said supporting element.

3. The device according to claim 1, which further comprises a movable wagon connected to said stack holder at said axis of rotation.

4. The device according to claim 1, wherein said supporting element has recesses, and a further supporting element of the bed has inverted recesses and is movable through said supporting element.

5. The device according to claim 3, wherein:
said supporting element has recesses, and a further supporting element of the bed has inverted recesses and is movable through said supporting element; and
said controllable drive for moving and pivoting said stack holder and for driving said conveyor is configured for:
upwardly pivoting said base with the stack about said axis of rotation toward said further supporting element or a stack on the bed when said wagon moves; and
downwardly pivoting said base and transporting the stack in said stack holder with said conveyor up to said further supporting element or to the stack on the bed, once said base has reached said further supporting element or the stack, causing the stack to abut against said further supporting element or the stack on the bed.

6. The device according to claim 5, wherein said controllable drive for moving and pivoting said stack holder and for driving said conveyor is configured for:
moving said wagon back after said further supporting element has moved outward and said supporting element has moved through from the rear to support the stack or after it has reached the stack on the bed.

7. The device according to claim 5, wherein said controllable drive for moving and pivoting said stack holder and for driving said conveyor is configured for:
moving said conveyor when said wagon moves back, so that a position of a surface holding objects is not changed.

8. The device according to claim 6, wherein said controllable drive for moving and pivoting said stack holder and for driving said conveyor is configured for:
moving said conveyor when said wagon moves back, so that a position of a surface holding objects is not changed.

9. The device according to claim 1, which further comprises a manually actuatable control module coupled to said conveyor and disposed on said supporting element for controlling a motor movement of said supporting element.

10. The device according to claim 9, wherein said supporting element has a free face, and said manually actuatable control module is disposed on said free face.

11. The device according to claim 9, wherein said control module has a manual operating mode in which a manual force is exerted on said control module to assist said movement.
